(19) United States
(12) Patent Application Publication
(10) Pub. No.: US 2023/0306332 A1
(43) Pub. Date: Sep. 28, 2023

(54) CONSUMABLE MANAGEMENT SYSTEM, NON-TRANSITORY COMPUTER READABLE MEDIUM STORING PROGRAM, AND CONSUMABLE MANAGEMENT METHOD

(71) Applicant: FUJIFILM Business Innovation Corp., Tokyo (JP)

(72) Inventor: Kento KOBAYASHI, Kanagawa (JP)

(73) Assignee: FUJIFILM Business Innovation Corp., Tokyo (JP)

(21) Appl. No.: 17/893,150

(22) Filed: Aug. 22, 2022

(30) Foreign Application Priority Data
Mar. 24, 2022 (JP) 2022-048797

(51) Int. Cl. G06Q 10/06

(52) U.S. Cl. CPC G06Q 10/06315

(57) ABSTRACT

A consumable management system includes a processor configured to acquire usage information of a consumable from an apparatus to be managed for which a collection time period is set, determine a replacement time period of the consumable based on the usage information, and provide an instruction of replacement or replenishment of the consumable in a case where the replacement time period satisfies a predetermined condition based on the collection time period and not to provide the instruction of the replacement or the replenishment of the consumable in a case where the replacement time period does not satisfy the condition.

### CROSS-REFERENCE TO RELATED APPLICATIONS

This application is based on and claims priority under 35 USC 119 from Japanese Patent Application No. 2022-048797 filed Mar. 24, 2022.

### BACKGROUND

### (i) Technical Field

The present invention relates to a consumable management system, a non-transitory computer readable medium storing a program, and a consumable management method.

### (ii) Related Art

Regarding management of consumables such as office apparatuses, the following operations are performed such that information on the usage amount of the consumables is acquired from an apparatus, a replacement time period is calculated, and a consumable near the replacement time period is being replaced or replenished. Further, in order to reduce waste in the use of the consumable, use of a recycled product and reuse of a used consumable have been proposed.

JP2003-280865A discloses a consumable management method in which a customer side apparatus that uses a consumable notifies a management device, which is a management source managing the consumable, of a degree of use of the consumable or a degree of the consumable, and when the management device detects that the consumable has been used to a predetermined degree of use or a predetermined degree of the consumable, a determination is made whether to provide the customer with a new consumable or to provide the customer with a recycled consumable in accordance with contract information registered in advance.

JP2008-185824A discloses a management system in which a management server 101 transmits an availability of a consumable part to an examination terminal 104 in a case where a determination is made that the consumable part being used is still usable, the examination terminal 104 examines whether the consumable part is usable, the consumable part is registered as inventory in a case where the consumable part is usable as a result of the examination, an image forming apparatus 106 transmits replacement request information of the consumable to the management server 101 in a case where the remaining life of the consumable part is less than a certain period, the management server 101 searches for necessary consumable part based on the replacement request information, and the management server 101 transmits information related to appropriate shipping processing to an inventory management terminal 105.

### SUMMARY

In a case where an apparatus is provided to a customer through a loan contract or the like, and the customer replaces consumables near a collection time period of the apparatus due to the expiration of the loan contract or the like, the apparatus is needed to be collected shortly after replacing the consumables, which sometimes resulted in waste in the use of the consumables.

Aspects of non-limiting embodiments of the present disclosure relate to a consumable management system, a non-transitory computer readable medium storing a program, and a consumable management method that reduces waste in the use of consumables by controlling provision of the consumables according to a collection time period of an apparatus as compared with a case where the consumables are replaced only according to a usage situation of the provided apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a consumable management system including a processor configured to acquire usage information of a consumable from an apparatus to be managed for which a collection time period is set, determine a replacement time period of the consumable based on the usage information, and provide an instruction of replacement or replenishment of the consumable in a case where the replacement time period satisfies a predetermined condition based on the collection time period and not to provide the instruction of the replacement or the replenishment of the consumable in a case where the replacement time period does not satisfy the condition.

### BRIEF DESCRIPTION OF THE DRAWINGS

Exemplary embodiment(s) of the present invention will be described in detail based on the following figures, wherein:

FIG. 1 is a diagram showing a configuration of a consumable management system to which the present exemplary embodiment is applied;

FIG. 2 is a diagram showing an example of a hardware configuration of a consumable management server and a delivery management server;

FIG. 3 is a diagram showing a configuration of an image forming apparatus to which the present exemplary embodiment is applied;

FIG. 4 is a diagram showing a functional configuration of the consumable management server;

FIG. 5 is a diagram showing a functional configuration of the delivery management server;

FIG. 6 is a flowchart showing an operation of the consumable management server;

FIG. 7 is a flowchart showing an operation of the consumable management server in a case where limit of a replenishment amount is determined in replenishment of a consumable; and

FIG. 8 is a flowchart showing an operation of the consumable management server at the time of collection of the image forming apparatus.

### DETAILED DESCRIPTION

Hereinafter, an exemplary embodiment of the present invention will be described in detail with reference to the accompanying drawings.

### Configuration of System

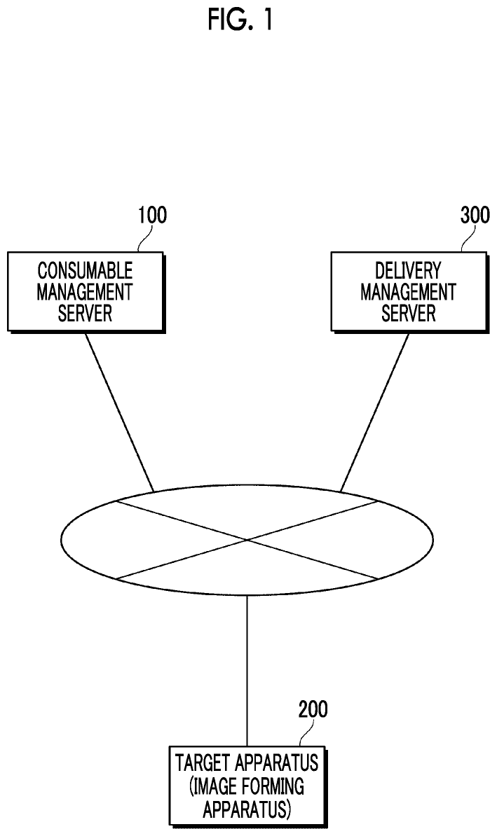

FIG. 1 is a diagram showing a configuration of a consumable management system to which the present exemplary embodiment is applied. The consumable management system shown in FIG. 1 includes a consumable management server 100, a target apparatus 200, and a delivery management server 300. The consumable management server 100, the target apparatus 200, and the delivery management server 300 are connected via a network. The target apparatus 200 may be any apparatus provided with a consumable managed by the present exemplary embodiment and is not particularly limited.

In the present exemplary embodiment, an assumption is made that the target apparatus 200 is provided to a provision destination (company or the like) through a contract or the like. Therefore, the target apparatus is collected from the provision destination in a case where a contract expiration or a collection instruction is issued. Further, in the present exemplary embodiment, an assumption is made that the target apparatus 200 may be moved from one installation place of the provision destination to another installation place during a contract period. For example, the target apparatus 200, which is provided to the company, may be rented out to an employee of the company and carried to the employee's house on a rotating basis. In this case, an assumption is made that the target apparatus 200, which is rented out to an employee's house of one employee is collected once and then rented out to an employee's house of another employee. In the present exemplary embodiment, a case where an image forming apparatus is used as an example of the target apparatus 200 will be described. Hereinafter, the image forming apparatus as the target apparatus 200 in the present exemplary embodiment will be referred to as an image forming apparatus 200.

The network connecting the consumable management server 100, the image forming apparatus 200, and the delivery management server 300 is not particularly limited as long as the network can be used for data communication among the apparatuses. For example, a local area network (LAN), a wide area network (WAN), the Internet, or the like may be used. A communication line used for the data communication may be a combination of the LAN, WAN, and the Internet, regardless of whether the communication line is wired or wireless. A configuration may be used such that a relay apparatus such as a gateway apparatus, a router, or an access point is used to connect each apparatus via a plurality of networks or communication lines.

### Hardware Configuration of Server

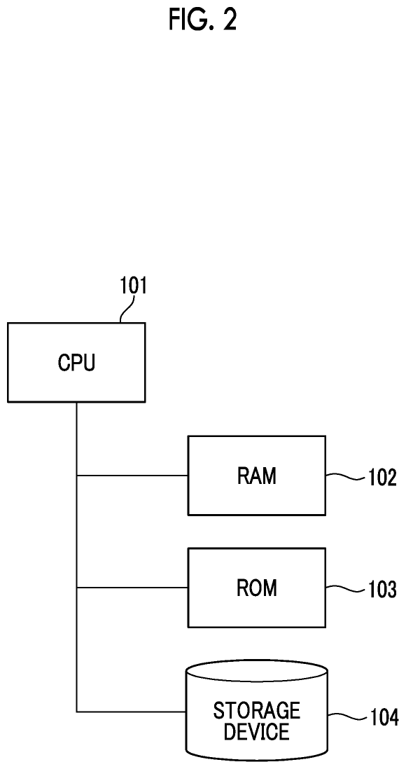

FIG. 2 is a diagram showing an example of a hardware configuration of the consumable management server 100 and the delivery management server 300. The consumable management server 100 and the delivery management server 300 are implemented by a computer on the network. Although the consumable management server 100 and the delivery management server 300 will be described here as a computer apparatus connected to the network, the consumable management server 100 and the delivery management server 300 may be implemented as a virtual server, a cloud server, or the like built by one or a plurality of computers connected to the network.

FIG. 2 is a diagram showing an example of the hardware configuration of a computer configuring the consumable management server 100. The computer configuring the consumable management server 100 includes a central processing unit (CPU) 101, a random access memory (RAM) 102, a read only memory (ROM) 103, and a storage device 104.

The CPU 101 is a calculation device, which executes a program to execute various processing and controls. The RAM 102 is a main storage device (main memory) and is used as a working memory in a case where the CPU 101 performs calculation processing. Data such as a program or a set value prepared in advance is stored in the ROM 103, and the CPU 101 can directly read the program or the data from the ROM 103 and execute processing. Functions for performing various data processing or controls in the consumable management server 100, which will be described later, are implemented, for example, by the CPU 101 executing a program.

The storage device 104 is a storage section of a program or data. The program is stored in the storage device 104, and the CPU 101 reads the program stored in the storage device 104 into the RAM 102 and executes the program. Further, the storage device 104 stores the result of processing by the CPU 101, and the result is stored. Specifically, the storage device 104 stores form data created by the consumable management server 100. Further, the storage device 104 stores information related to a user of the consumable management server 100. The information related to the user is used to create the form data. As the storage device 104, for example, a magnetic disk device, a solid state drive (SSD), or the like is used.

In the consumable management server 100 and the delivery management server 300, various functions described later are implemented by the CPU 101 reading and executing the program. The consumable management server 100 implements functions such as acquisition of usage information of a consumable, estimation of a replacement time period of the consumable, and determination of whether to replace or replenish the consumable, for example. Further, the delivery management server 300 implements functions such as inventory management of the consumable and notification of a delivery instruction, for example. A time period, when replacement is required for a consumable (for example, a photoconductor drum) for which the replacement is required according to a state, and a time period, when replenishment is required for a consumable (for example, toner or paper) for which the replenishment is required according to a state, are collectively referred to as a “replacement time period”.

### Hardware Configuration of Image Forming Apparatus 200

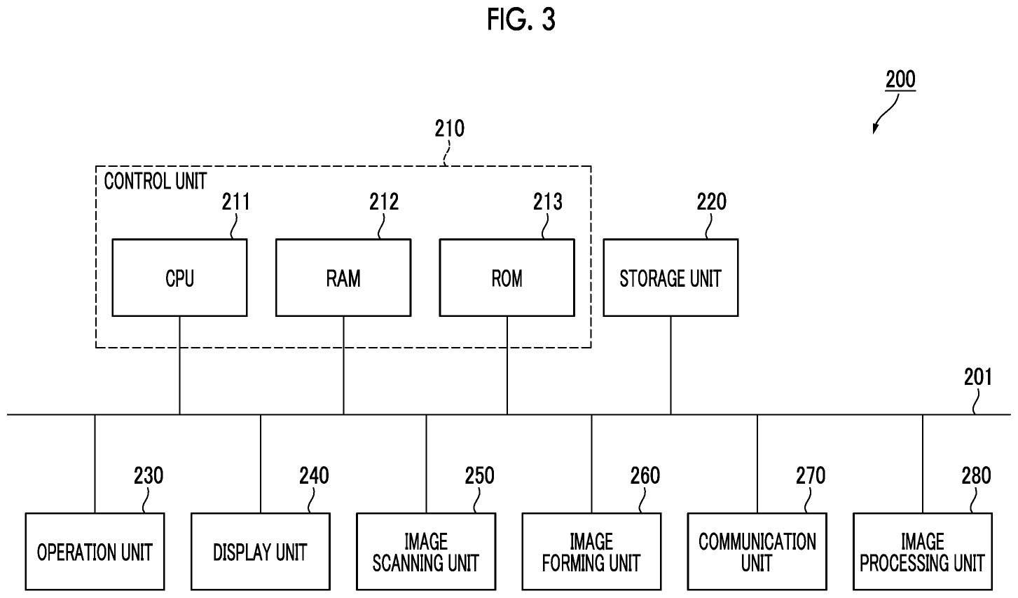

FIG. 3 is a diagram showing a configuration of the image forming apparatus to which the present exemplary embodiment is applied. The image forming apparatus 200 includes a control unit 210, a storage unit 220, an operation unit 230, a display unit 240, an image scanning unit 250, an image forming unit 260, a communication unit 270, and an image processing unit 280. Each of these functional units is connected to a bus 201 and performs reception of data via the bus 201.

The control unit 210 controls each of the above-mentioned functional units in the image forming apparatus 200. Further, the control unit 210 is a functional unit that executes various data processing. The control unit 210 includes a central processing unit (CPU) 211 which is a calculator, and a random access memory (RAM) 212 and a read only memory (ROM) 213 which are memories. The RAM 212 is a main storage device (main memory) and is used as a working memory in a case where the CPU 211 performs calculation processing. Data such as a program or a set value prepared in advance is stored in the ROM 213, and the CPU 211 directly reads the program or the data from the ROM 213 and executes processing. Further, the program or data is also stored in the storage unit 220. The CPU 211 reads the program stored in the storage unit 220 into the RAM 212 and executes the program.

In the present exemplary embodiment, the control unit 210 acquires usage information of the consumable by the CPU 211 reading and executing the program. The image forming apparatus 200 is provided with various sensors (not shown) for obtaining information related to an operation or a state of the consumable. The control unit 210 acquires data from the sensor and stores the data in, for example, the storage unit 220. The control unit 210 reads the data of the consumable stored in the storage unit 220 according to a predetermined transmission condition (for example, periodically) and transmits the data to the consumable management server 100 as the usage information of the consumable.

The storage unit 220 is a functional unit that stores the program or data for the CPU 211 to execute as described above and also stores various data, which is generated by various operations, such as image data scanned by an image scanning unit 250. The storage unit 220 is implemented by, for example, a storage device such as a magnetic disk device ora solid state drive (SSD) . Further, in the present exemplary embodiment, the consumable data acquired from the sensor by the control unit 210 as described above is temporarily stored in the storage unit 220.

The operation unit 230 is a functional unit that receives a user operation. The operation unit 230 is configured with, for example, a hardware key, a touch sensor that outputs a control signal according to a position pressed or touched by a finger, or the like. The operation unit 230 maybe configured as a touch panel in which a touch sensor and a liquid crystal display constituting the display unit 240 are combined.

The display unit 240 is a functional unit that displays an information image that presents various information to a user, a preview image of an image to be processed such as scanning or outputting, an operation image for the user to perform an operation, and the like. The display unit 240 is configured with, for example, a liquid crystal display. The operation unit 230 and the display unit 240 can be combined and used as a user interface unit for the user to input and output information to and from the image forming apparatus 200.

The image scanning unit 250 is a functional unit that optically scans an image on a document. Examples of an image scanning method include a charge coupled device (CCD) method in which the reflected light to light emitted from a light source to a document is reduced by the lens and received by the CCDs, a contact image sensor (CIS) method in which the reflected light to light emitted from a light emitting diode (LED) light source to the document in order is received by the CIS, and the like.

The image forming unit 260 is a functional unit that forms an image based on image data on a medium such as paper by using an image forming material. An example of a method of forming an image on the medium includes an electrophotographic method of using toner as an image forming material and transferring the toner adhering to the photoconductor to a medium to form an image.

The communication unit 270 is a functional unit that transmits and receives a command or data to and from between the communication unit 270 and the external apparatus. An example of the communication unit 270 includes an interface that corresponds to a communication method with the external apparatus. The connection with the external apparatus may be made via a network or may be made via a direct connection. A communication line may be a wired line or a wireless line.

The image processing unit 280 is a functional unit that includes a processor that is a calculator and a working memory and performs the image processing such as color correction or gradation correction on the image represented by the image data. The CPU 211 of the control unit 210 may be used as the processor, and the RAM 212 of the control unit 210 may be used as the working memory, in combination, respectively.

### Functional Configuration of Consumable Management Server 100

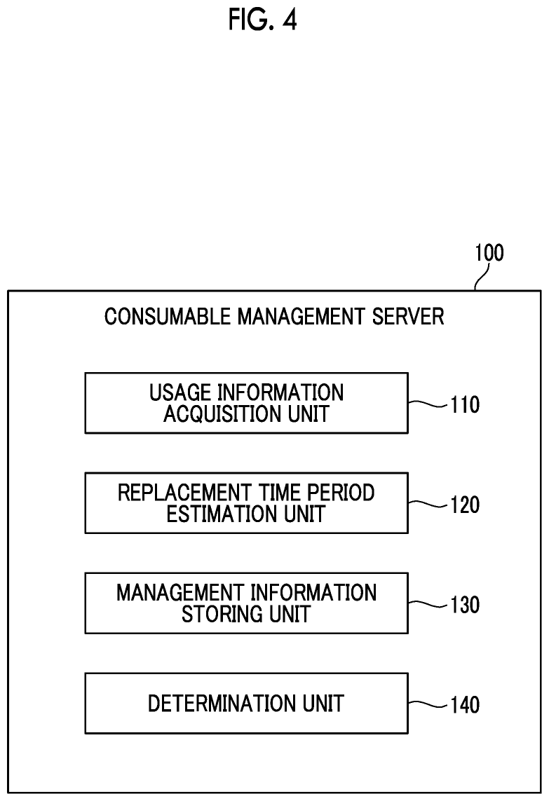

FIG. 4 is a diagram showing a functional configuration of the consumable management server 100. The consumable management server 100 includes a usage information acquisition unit 110, a replacement time period estimation unit 120, a management information storing unit 130, and a determination unit 140.

The usage information acquisition unit 110 acquires the usage information of the consumable from the image forming apparatus 200 to be managed. The usage information acquisition unit 110 is, for example, a functional unit implemented by the CPU 101 shown in FIG. 2 executing a program. The usage information of the consumable is, for example, periodically transmitted from the image forming apparatus 200. Further, in a case where the collection time period for collecting from the provision destination is designated with respect to the specific image forming apparatus 200, the usage information of the consumable may be acquired at the specific time period based on the collection time period. The usage information acquisition unit 110 may acquire the usage information of the image forming apparatus 200 in addition to the usage information of individual consumables. Examples of the usage information of the image forming apparatus 200 include operation logs of the image forming apparatus 200.

The replacement time period estimation unit 120 estimates the replacement time period according to a usage state, a usage period, a usage frequency, or the like of the consumable based on the usage information acquired by the usage information acquisition unit 110. The replacement time period estimation unit 120 is, for example, a functional unit implemented by the CPU 101 shown in FIG. 2 executing a program. Further, the replacement time period estimation unit 120 may have a function of estimating how much the consumable is able to be used by a specific time period according to the usage state, the usage period, the usage frequency, or the like of the consumable.

The management information storing unit 130 stores management information of the image forming apparatus 200 to be managed. The management information storing unit 130 is implemented by, for example, the storage device 104 shown in FIG. 2. The management information also includes information such as the collection time period of the image forming apparatus 200 or whether the image forming apparatus 200 is moved to another place of the provision destination after the collection. Further, in a case where the image forming apparatus 200 is provided through a contract, information on the contract contents including the contract expiration time period and the like may be stored. For example, after each information is set, such as when the image forming apparatus 200 is provided or when the contract is set, the information is input to the consumable management server 100 and is stored in the management information storing unit 130.

The determination unit 140 determines whether to provide an instruction for replacing the consumable for which the replacement is required or provide an instruction for replenishing the consumable for which the replenishment is required (hereafter, referred to as a “replacement or replenishment instruction”). The determination unit 140 is, for example, a functional unit implemented by the CPU 101 shown in FIG. 2 executing a program. In a case where the replacement time period of the consumable that is estimated by the replacement time period estimation unit 120 satisfies a predetermined condition, the determination unit 140 provides the replacement or replenishment instruction of the consumable.

Examples of the condition for providing the replacement or replenishment instruction include, first, a condition such that a period until the estimated replacement time period is shorter than a period (hereafter, referred to as a “threshold period”) set as a threshold value in advance, and the like. The threshold period is set in consideration of the estimation accuracy of the replacement time period, delivery of a consumable, replacement work or replenishment work, inventory securing, and the like. The threshold period may be individually determined according to the type of a consumable, and the replacement or replenishment instruction may be provided at the time when the estimated replacement time period comes (the threshold period=0) depending on the consumable.

Further, as a condition for performing the replacement or replenishment instruction, there is a condition based on a relationship between the replacement time period and the collection time period of the image forming apparatus 200. For example, in a case where the collection time period is earlier than the estimated replacement time period, the image forming apparatus 200 is collected before the replacement time period, so that the replacement or replenishment of the consumable is not necessary. Therefore, the condition based on the collection time period (for example, the condition that “the replacement time period is earlier than the collection time period) is set in advance, and the determination unit 140 provides the replacement or replenishment instruction of the consumable in a case where the condition is satisfied and does not provide the replacement or replenishment instruction of the consumable in a case where the condition is not satisfied.

Here, the determination unit 140 may provide an instruction for limiting the replenishment amount in the replenishment instruction of the consumable for which the replenishment is required in a case where the replacement time period satisfies the condition based on the collection time period. The determination unit 140 estimates the usage amount used until the collection time period after the consumable is replenished based on the usage information of consumable acquired from the image forming apparatus 200 and the estimated replacement time period. Thereafter, the determination unit 140 determines whether to replenish the full amount or to replenish the limited amount according to the estimation result. As the condition for limiting the replenishment amount, a condition may be set based on the usage amount of the consumable that is estimated to be used during the period until the collection time period after the consumable is replenished. For example, in a case where an estimation is made that substantially 10% of the full amount is to be used until the collection time period after the consumable is replenished, the consideration is made that the replenishment amount is set to substantially 30% to 50% of the full amount.

As the consumable for which the replenishment is required, toner or paper is used. The consideration is made that, in the case of toner, a toner cartridge, which is filled with the full amount of toner in advance, and a toner cartridge, which is filled with a smaller amount of toner than the full amount, are prepared, and the toner cartridge having a smaller amount of toner is delivered according to the determination of the determination unit 140. As the toner cartridge that is filled with a smaller amount of toner than the full amount, for example, a used toner cartridge that is taken out from the collected image forming apparatus 200 may be used. In a case where the used product is used, the amount of toner content can be estimated from the usage information of the used toner cartridge. In a case where the limited consumable is paper, the replenishment amount may be limited by the number of bundles delivered.

In a case where the image forming apparatus 200 is collected from the current installation place of the provision destination and then is re-installed at another installation place of the same provision destination, the determination unit 140 may replenish the full amount without limiting the replenishment amount even in a case where the condition for limiting the replenishment amount is satisfied. This is because the image forming apparatus 200 continues to be provided to the same provision destination even after the image forming apparatus 200 is collected and moved.

Further, even in a case where the replacement time period does not satisfy the condition based on the collection time period, in a case where the image forming apparatus 200 is installed at another installation place of the same provision destination after the image forming apparatus 200 is collected from the current installation place of the provision destination, the determination unit 140 may provide the replacement or replenishment instruction of the consumable in a case where the image forming apparatus 200 is installed in a new installation place. This is to avoid the need of performing the replacement or the replenishment of the consumable in a short period after moving the image forming apparatus 200 to a new installation place.

Further, even in a case where the replacement time period does not satisfy the condition based on the collection time period, and the image forming apparatus 200 is installed at another installation place of the same provision destination after the image forming apparatus 200 is collected from the current installation place of the provision destination, the determination unit 140 may not provide the replacement or replenishment instruction of the consumable in specific cases. For example, a threshold value is set for the remaining amount of the consumable, and in a case where the remaining amount of the consumable at the time of collection of the image forming apparatus 200 is larger than the threshold value, the replacement or replenishment instruction is not provided. The threshold value may be set based on a relationship between the usage frequency or the number of times of use after the replenishment, and the period from the replenishment to the collection, for example, for the use of the consumable in the operation of the image forming apparatus 200.

### Functional Configuration of Delivery Management Server 300

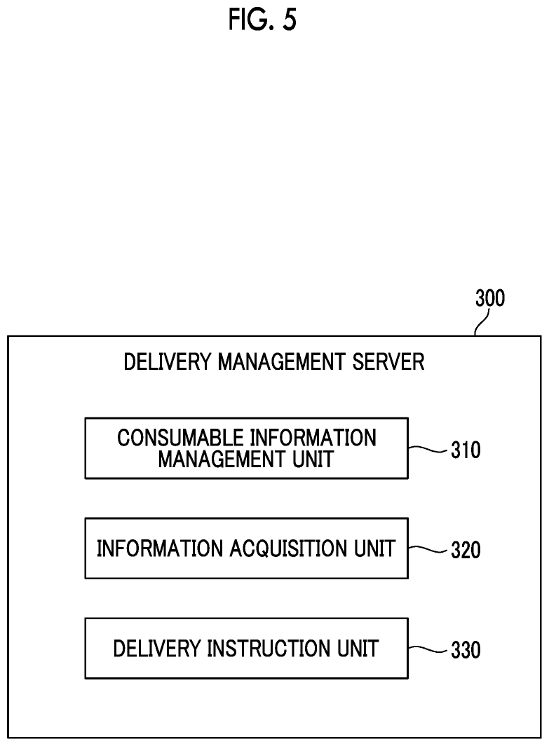

FIG. 5 is a diagram showing a functional configuration of the delivery management server 300. The delivery management server 300 includes a consumable information management unit 310, an information acquisition unit 320, and a delivery instruction unit 330.

The consumable information management unit 310 manages information such as a state of the consumable to be delivered. The consumable information management unit 310 is implemented by, for example, a functional unit implemented by the CPU 101 shown in FIG. 2 executing a program and the storage device 104. Examples of information such as the state of the consumable include information such as whether the consumable is a new product or a used product, a built-in amount, a usage history or a remaining amount in a case of the used product, and the like.

The information acquisition unit 320 acquires a delivery instruction and information on a consumable to be delivered from the consumable management server 100. Examples of the information on the consumable to be delivered include information on designating the built-in amount in a case where the replenishment amount is limited, information on whether to use a used product, and the like.

The delivery instruction unit 330 notifies a delivery person of the consumable of the delivery instruction. The delivery instruction also includes information on designating the state or the like of the consumable to be delivered. For example, the information on whether to use a new product or a used product, information on the replenishment amount, and the like are included. In a case where the delivery person receives the notification, the delivery person carries out the consumable that is corresponding to the delivery instruction from the storage place of the inventory of the consumable and delivers the consumable.

### Operation of Consumable Management Server 100

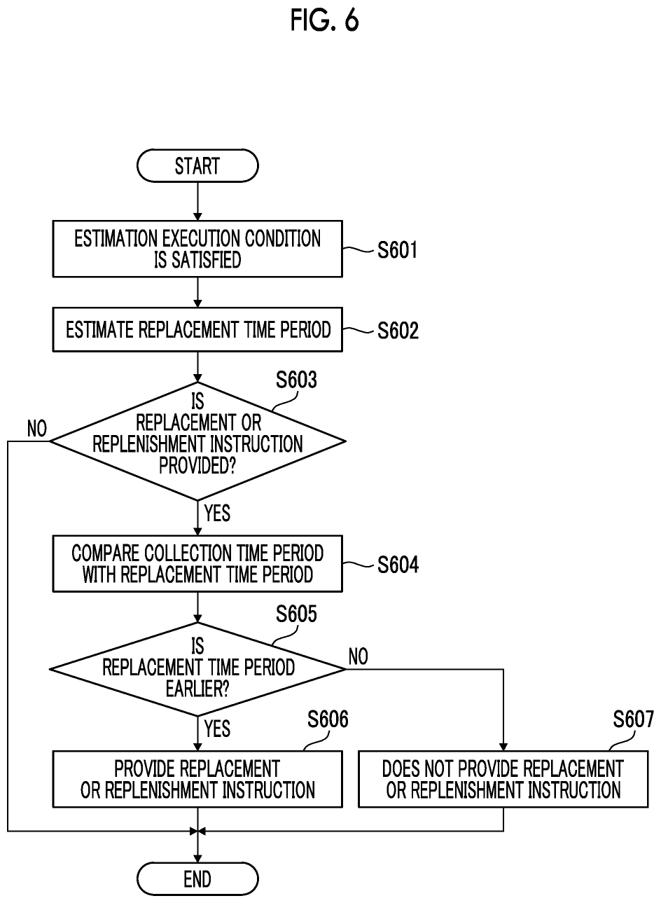

FIG. 6 is a flowchart showing an operation of the consumable management server 100. In a case where the consumable management server 100 satisfies the condition for executing the estimation of the replacement time period of the consumable (hereinafter, an “estimation execution condition”) (S601), the replacement time period estimation unit 120 estimates the replacement time period of the target consumable. (S602). Examples of the estimation execution condition include a fact that the number of times of job execution or operating time by the image forming apparatus 200 has reached a predetermined threshold value, a fact that a certain period has passed since the last estimation or the job has been executed a certain number of times, a fact that a period until the collection time period of the image forming apparatus 200 is shorter than a period set as a predetermined threshold value, a fact that a collection request of the image forming apparatus 200 has been received, and the like. In a case where the estimated replacement time period does not satisfy the condition for providing the replacement or replenishment instruction (NO in S603), the operation is ended since the replacement or the replenishment of the consumable is not necessary.

In a case where the estimated replacement time period satisfies the condition for providing the replacement or replenishment instruction (YES in S603), the determination unit 140 of the consumable management server compares the collection time period, which is set for the image forming apparatus 200, with the estimated replacement time period (S604). Thereafter, in a case where the replacement time period is earlier (YES in S605), the determination unit 140 of the consumable management server 100 provides the replacement or replenishment instruction (S606). Here, in a case where the collection time period for the image forming apparatus 200 is not set, the determination unit 140 determines YES in S605, and the determination unit 140 of the consumable management server 100 provides the replacement or replenishment instruction (S606). On the other hand, in a case where the collection time period is earlier (NO in S605), the determination unit 140 of the consumable management server 100 does not provide the replacement or replenishment instruction (S607).

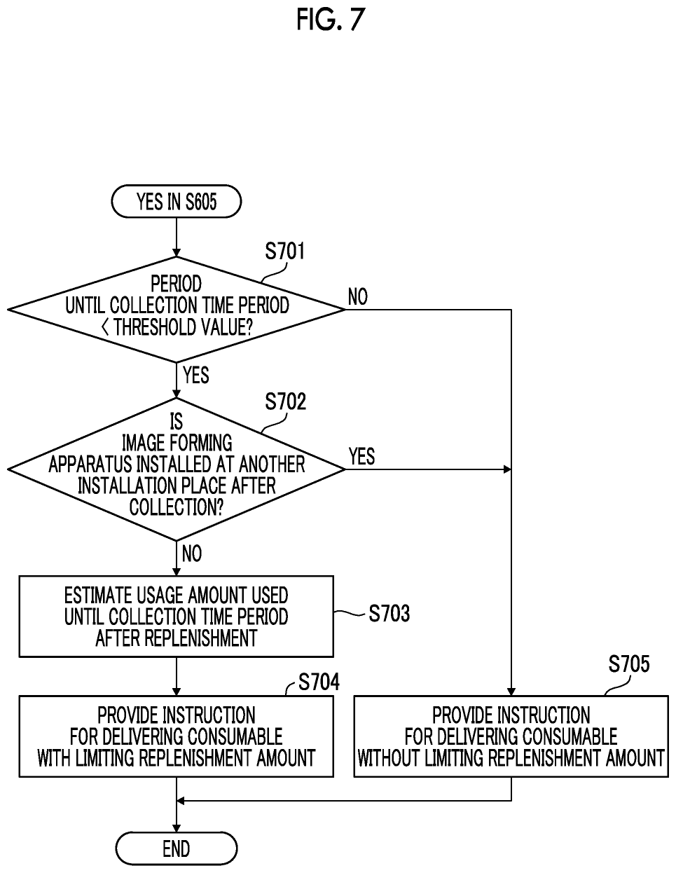

FIG. 7 is a flowchart showing an operation of the consumable management server 100 in a case where limit of a replenishment amount is determined in replenishment of a consumable. FIG. 7 shows an operation after determining that the replacement or replenishment instruction is provided in S605 of FIG. 6 (YES). In the above operation, the consumable to be determined is defined as a consumable for which the replenishment is required according to the state of the consumable.

In a case where the replacement or replenishment instruction is provided, the determination unit 140 of the consumable management server 100 determines whether the period until the collection time period of the image forming apparatus 200 is shorter than the period set as the threshold value in advance. In a case where the period until the collection time period is longer than the threshold value (NO in S701), the determination unit 140 provides an instruction for delivering the consumable without limiting the replenishment amount in the replacement or replenishment instruction (S705).

In a case where the period until the collection time period is shorter than the threshold value (YES in S701), the determination unit 140, for example, takes into consideration the management information of the image forming apparatus 200, which is stored in the management information storing unit 130, and determines whether the image forming apparatus 200 is installed at another installation place of the same provision destination after the collection. In a case where the image forming apparatus 200 is installed at another installation place (YES in S702), the determination unit 140 provides an instruction for delivering the consumable without limiting the replenishment amount in the replacement or replenishment instruction (S705).

On the other hand, in a case where the image forming apparatus 200 is not installed at another installation place of the same provision destination after the collection (NO in S702), the determination unit 140 estimates the usage amount of the consumable to be determined which is used until the collection time period of the image forming apparatus 200 after the replenishment (S703). The estimation of the usage amount may include a function of estimating the usage amount of consumable to be used until a specific time period by the replacement time period estimation unit 120. The determination unit 140 provides an instruction for delivering the consumable with limiting the replenishment amount in the replacement or replenishment instruction based on the estimation result of the usage amount of the consumable used until the collection time period (S704).

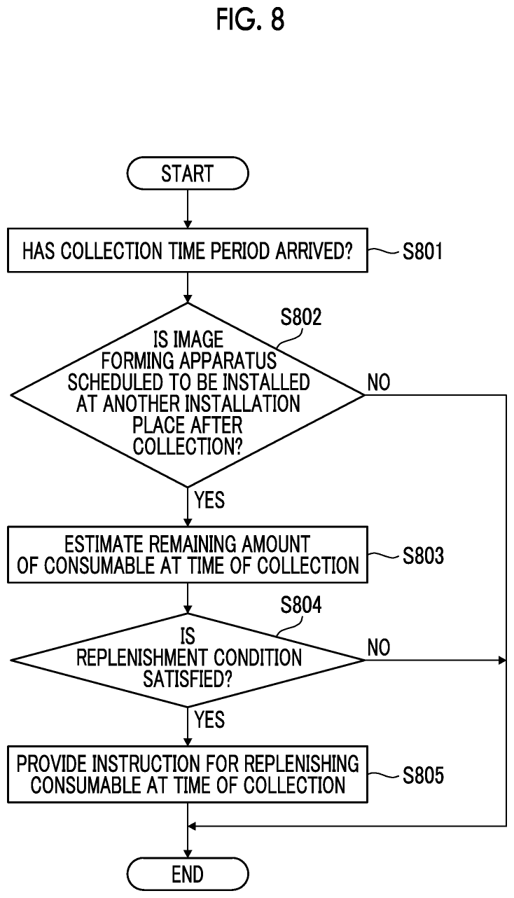

FIG. 8 is a flowchart showing an operation of the consumable management server 100 at the time of collection of the image forming apparatus 200. The operation can be performed in a case where a determination is made that the replacement or replenishment instruction is not performed (NO) in S605 of FIG. 6. In the above operation, the consumable to be determined is defined as a consumable for which the replenishment is required according to the state of the consumable.

In a case where the collection time period of the image forming apparatus 200 has arrived (S801), the determination unit 140 of the consumable management server 100 determines whether the image forming apparatus 200 is scheduled to be installed at another installation place of the same provision destination after the collection. The determination is made in consideration of the management information of the image forming apparatus 200 stored in the management information storing unit 130. In a case where the image forming apparatus 200 is not scheduled to be installed at another installation place (NO in S802), the processing is ended since the replacement or the replenishment of the consumable is not necessary.

In contrast to this, in a case where the image forming apparatus 200 is scheduled to be installed at another installation place after the collection (YES in S802), the determination unit 140 estimates the remaining amount of the consumable at the time of the collection (S803). The estimation is performed, for example, in consideration of the usage information of the image forming apparatus 200 that is periodically acquired by the usage information acquisition unit 110. Further, the remaining amount of the consumable specified in the usage information that is lastly acquired before the collection may be defined as the remaining amount at the time of collection.

In a case where the estimated remaining amount of the consumable satisfies the replenishment condition (YES in S804), the determination unit 140 provides an instruction for replenishing the consumable to the delivery management server 300 at the time of the collection (S805). Examples of the replenishment condition include a condition such that the estimated remaining amount of the consumable is less than a predetermined threshold value, and the like. On the other hand, in a case where the estimated remaining amount of the consumable does not satisfy the replenishment condition (NO in S804), the determination unit 140 ends the processing since the replacement or the replenishment of the consumable is not necessary.

Although the exemplary embodiments of the present invention have been described above, the technical scope of the exemplary embodiment of the present invention is not limited to the above exemplary embodiment. For example, in the above exemplary embodiment, an example in which the image forming apparatus is used as the target apparatus 200 has been described, but the application target of the present exemplary embodiment is not limited to the above example. The present exemplary embodiment may be applied to the management of consumables for various apparatuses including consumables that need to be replaced or replenished periodically or according to a state. Various changes and alternative configurations that do not deviate from the scope of the technical idea of the exemplary embodiment of the present invention are included in the exemplary embodiment of the present invention.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A consumable management system comprising:
a processor configured to:
acquire usage information of a consumable from an apparatus to be managed for which a collection time period is set;
determine a replacement time period of the consumable based on the usage information; and
provide an instruction of replacement or replenishment of the consumable in a case where the replacement time period satisfies a predetermined condition based on the collection time period and not to provide the instruction of the replacement or the replenishment of the consumable in a case where the replacement time period does not satisfy the condition.

2. The consumable management system according to claim 1, wherein the processor is configured to:
in a case where the replacement time period satisfies the predetermined condition based on the collection time period, limit a replenishment amount of the consumable, for which the replenishment is required, in the instruction, according to a period during the replacement time period and the collection time period.

3. The consumable management system according to claim 2, wherein the processor is configured to:
in a case where, after the apparatus is collected from an installation place of a provision destination, the apparatus is installed at another installation place of the provision destination, not to limit the replenishment amount even in a case where the period during the replacement time period and the collection time period satisfies a condition of limiting the replenishment amount of the consumable.

4. The consumable management system according to claim 1, wherein the processor is configured to:
in a case where the replacement time period does not satisfy the predetermined condition based on the collection time period, and in a case where, after the apparatus is collected from an installation place of a provision destination, the apparatus is installed at another installation place of the provision destination, provide the instruction of the replacement or the replenishment of the consumable according to the installation of the apparatus at the other installation place.

5. The consumable management system according to claim 4, wherein the processor is configured to:
in a case where a predetermined condition for use of the consumable is satisfied, not to provide the instruction of the replacement or the replenishment of the consumable even in a case where, after the apparatus is collected from the installation place of the provision destination, the apparatus is installed at the other installation place of the provision destination.

6. A non-transitory computer readable medium storing a program causing a computer to execute:
a function of acquiring usage information of a consumable from an apparatus to be managed for which a collection time period is set;
a function of determining a replacement time period of the consumable based on the usage information; and
a function of providing an instruction of replacement or replenishment of the consumable in a case where the replacement time period satisfies a predetermined condition based on the collection time period and not providing the instruction of the replacement or the replenishment of the consumable in a case where the replacement time period does not satisfy the condition.

7. A consumable management method comprising:
acquiring usage information of a consumable from an apparatus to be managed for which a collection time period is set;
determining a replacement time period of the consumable based on the usage information; and
providing an instruction of replacement or replenishment of the consumable in a case where the replacement time period satisfies a predetermined condition based on the collection time period and not providing the instruction of the replacement or the replenishment of the consumable in a case where the replacement time period does not satisfy the condition.
